(19) United States
(12) Patent Application Publication
(10) Pub. No.: US 2018/0052348 A1
(43) Pub. Date: Feb. 22, 2018

(54) LIQUID CRYSTAL DISPLAY APPARATUS AND METHOD OF MANUFACTURING THE SAME

(71) Applicant: Samsung Display Co., Ltd., Yongin-si (KR)

(72) Inventors: Seung-Won Park, Seoul (KR); Eunjung KIM, Suwon-si (KR); Taewoo KIM, Seoul (KR); Jung Gun NAM, Suwon-si (KR); Daehwan JANG, Seoul (KR); Hyungbin CHO, Seongnam-si (KR); Gugrae JO, Asan-si (KR)

(21) Appl. No.: 15/668,312

(22) Filed: Aug. 3, 2017

(30) Foreign Application Priority Data
Aug. 16, 2016 (KR) 10-2016-0103557

(51) Int. Cl. G02F 1/1333; G02F 1/1337

(52) U.S. Cl. CPC G02F 1/13336; G02F 2001/1635; G02F 1/133345; G02F 1/133707

(57) ABSTRACT

A liquid crystal display apparatus includes a first substrate, a second substrate spaced from the first substrate, and a liquid crystal layer disposed between the first substrate and the second substrate. The first substrate includes a first base substrate, a wire grid polarizer disposed on the first base substrate, and a first alignment layer disposed on the first base substrate and including photo-alignment material, wherein the first alignment layer includes a first area in which photo-alignment is performed and a second area in which photo-alignment is not performed. A method of manufacturing the apparatus is also disclosed.

### CROSS-REFERENCE TO RELATED APPLICATION

This application claims priority from and the benefit of Korean Patent Application No. 10-2016-0103557, filed on Aug. 16, 2016, which is hereby incorporated by reference for all purposes as if fully set forth herein.

### BACKGROUND

### Field

The invention relates generally to a liquid crystal display apparatus and a method of manufacturing the liquid crystal display apparatus, and, more particularly, to a liquid crystal display apparatus and method of manufacturing same in which an alignment layer is formed by a photo-alignment method.

### Discussion of the Background

Recently, a display apparatus having a light weight and a small size has been manufactured. A cathode ray tube (CRT) display apparatus has been used due to performance and a competitive price. However the CRT display apparatus has a larger size and weight than other types of display apparatus and thus relatively poorer portability. Therefore a display apparatus such as a plasma display apparatus, a liquid crystal display apparatus and an organic light emitting display apparatus have been highly regarded due to relatively smaller size, lighter weight and lower-power-consumption.

The liquid crystal display apparatus applies a voltage to specific molecular arrangement configured to change the molecular arrangement. The liquid crystal display apparatus displays an image using changes of an optical property (for example, birefringence, rotatory polarization, dichroism and/or light scattering) of a liquid crystal cell according to the changes of the molecular arrangement.

The liquid crystal display apparatus may include an alignment means for initial alignment of the liquid crystal. The alignment layer can be formed through a rubbing process or a photo-alignment process. The photo-alignment process, in being a noncontact process, has various advantages. However, for the above-described photo-alignment process, there is a problem in that a polarized light emitting device is required and an additional alignment process for aligning the direction of the photo-alignment process and the direction of a polarizer of the liquid crystal display device is required. Thus, the foregoing manufacturing process is complicated and requires several alignment process steps.

The above information disclosed in this Background section is only for enhancement of understanding of the background of the inventive concepts, and, therefore, it may contain information that does not form the prior art that is already known in this country to a person of ordinary skill in the art.

### SUMMARY

Liquid crystal display apparatuses and methods according to the principles of the invention form an alignment layer by a simplified photo-alignment method. For example, the liquid crystal display apparatus may include a wire grid polarizer and an alignment layer, which may include one or more areas where photo-alignment is performed and one or more areas in which photo-alignment is not performed. During manufacture of the liquid crystal display apparatus, un-polarized ultraviolet light is polarized as it passes through the wire grid polarizer, thereby obviating the need for polarized ultraviolet light and obviating additional process steps for aligning the alignment direction of the alignment layer and the polarizer.

Additional aspects will be set forth in the detailed description which follows, and, in part, will be apparent from the disclosure, or may be learned by practice of the inventive concepts.

According to one aspect of the invention, a liquid crystal display apparatus includes a first substrate, a second substrate spaced from the first substrate, and a liquid crystal layer disposed between the first substrate and the second substrate. The first substrate includes a first base substrate, a wire grid polarizer disposed on the first base substrate, and a first alignment layer disposed on the first base substrate and including photo-alignment material, wherein the first alignment layer includes a first area in which photo-alignment is performed and a second area in which photo-alignment is not performed.

The first substrate may include a metal pattern layer. The first area may overlap the metal pattern layer.

The metal pattern layer may include a gate pattern having a gate electrode, and a data pattern having a drain electrode and a source electrode.

A photo-alignment direction of the first alignment layer and a photo-alignment direction of the second alignment layer may be substantially the same.

The second substrate may include a second base substrate, and a second alignment layer disposed on the second base substrate and including a photo-alignment material, wherein the second alignment layer has a first area in which photo-alignment has been performed and a second area in which photo-alignment has not been performed.

The second substrate may further include a black matrix which blocks light. The black matrix may be larger than the second area, and entirely overlapping the second area.

The first substrate may include a color filter between the first base substrate and the first alignment layer.

The second substrate may include a color filter disposed on the second base substrate.

A pitch of the wire grid polarizer may be about 50 nm to about 150 nm.

The first substrate may be a lower substrate and the second substrate may be an upper substrate.

The first substrate may be an upper substrate and the second substrate may be a lower substrate.

According to another aspect of the invention, a method of manufacturing a liquid crystal display apparatus includes the steps of providing a lower substrate having a first base substrate and a wire grid polarizer disposed on the first base substrate, forming a preliminary lower alignment layer having photo-alignment material on the lower substrate, and irradiating ultraviolet light through the wire grid polarizer into the preliminary lower alignment layer, thereby forming a photo-aligned lower alignment layer.

The method may further include providing an upper substrate including a second base substrate, forming a preliminary upper alignment layer including photo-alignment material on the upper substrate, and forming a liquid crystal layer between the lower substrate and the upper substrate. Irradiating the ultraviolet light may be performed after the step of forming the liquid crystal layer. The ultraviolet light may sequentially pass through the wire grid polarizer and the liquid crystal layer and may be irradiated into the preliminary upper alignment layer, thereby photo-aligning the lower alignment layer and the upper alignment layer.

In the step of irradiating the ultraviolet light, the liquid crystal layer may be in OFF state, whereby the ultraviolet light passing through the liquid crystal layer may maintain its state of polarization.

The method may further include photo-aligning the lower alignment layer and photo-aligning the upper alignment layer in substantially the same direction.

The step of providing a lower substrate may include providing a lower substrate having a metal pattern layer. The step of irradiating light into the preliminary lower alignment layer may include irradiating the ultraviolet light into a first area of the preliminary lower alignment layer and not irradiating the ultraviolet light into a second area of the preliminary lower alignment layer. The first area may overlap the metal pattern layer.

The step of irradiating the ultraviolet light may include generating un-polarized ultraviolet light from an ultraviolet irradiator and irradiating the un-polarized ultraviolet light towards the first substrate in an un-polarized state, whereby the ultraviolet light may be polarized by passing through the wire grid polarizer.

The step of irradiating the ultraviolet light may include generating ultraviolet light having a peak wavelength of about 300 nm (nanometer) to about 500 nm.

According to another aspect of the invention, a method of manufacturing a liquid crystal display apparatus includes the steps of providing a lower substrate having a first base substrate and a thin film transistor formed on the first base substrate, providing an upper substrate having a second base substrate and a wire grid polarizer formed on the second base substrate, forming a preliminary upper alignment layer including a photo-alignment material on the upper substrate, and irradiating un-polarized ultraviolet light through the wire grid polarizer into the preliminary upper alignment layer, thereby forming a photo-aligned upper alignment layer.

The method may further include forming a preliminary lower alignment layer having a photo-alignment material on the lower substrate, and forming a liquid crystal layer between the lower substrate and the upper substrate. The step of irradiating the un-polarized ultraviolet light may be performed after the step of forming the liquid crystal layer. The un-polarized ultraviolet light may sequentially pass through the wire grid polarizer and the liquid crystal layer and into the preliminary lower alignment layer, thereby photo-aligning the lower alignment layer and the upper alignment layer.

Thus, in various exemplary embodiments of the invention, a liquid crystal display apparatus includes a wire grid polarizer and an alignment layer, which includes a first area in which photo-alignment is performed and a second area in which photo-alignment is not performed. In manufacturing the liquid crystal display apparatus, since un-polarized ultraviolet light is polarized as it passes through the wire grid polarizer of the liquid crystal display apparatus, an additional ultraviolet irradiator alignment process for aligning the alignment direction of the alignment layer and the polarizer of the display apparatus is obviated.

In addition, since the wire grid polarizer of the liquid crystal display apparatus is used to polarize the ultraviolet light, the photo-alignment of an upper alignment layer and a lower alignment layer can be performed at the same time in one process.

In addition, in the above one step process, since the alignment direction of the upper alignment layer and the alignment direction of the lower alignment layer are substantially the same, the contrast ratio is improved and display quality can be improved.

In addition, an ultraviolet irradiator need not be configured to emit polarized ultraviolet light, and general ultraviolet lamps can be used for the ultraviolet irradiator.

In addition, if black matrix is larger than the second area where the photo-alignment is not performed, an alternating current (AC) afterimage due to liquid crystal control failure in the second area might not be recognized by the user.

The foregoing general description and the following detailed description are exemplary and explanatory and are intended to provide further explanation of the claimed subject matter.

### BRIEF DESCRIPTION OF THE DRAWINGS

The accompanying drawings, which are included to provide a further understanding of the inventive concepts, and are incorporated in and constitute a part of this specification, illustrate exemplary embodiments of the inventive concepts, and, together with the description, serve to explain principles of the inventive concepts.

FIG. 1 is a cross-sectional view of a first embodiment of a liquid crystal display apparatus constructed according to the principles of the invention;

FIG. 2 is a cross-sectional view of a second embodiment of a liquid crystal display apparatus constructed according to the principles of the invention;

FIGS. 3A to 3D are cross-sectional views of the display apparatus of FIG. 1 at various stages of construction in a first embodiment of a method of manufacturing the display apparatus according to the principles of the invention;

FIGS. 4A to 4D are cross-sectional views of the display apparatus of FIG. 1 at various stages of construction in a second embodiment of a method of manufacturing a display apparatus according to the principles of the invention;

FIGS. 5A to 5D are cross-sectional views of the display apparatus of FIG. 2 at various stages of construction in a third embodiment of a method of manufacturing a display apparatus according to the principles of the invention; and

FIGS. 6A to 6D are cross-sectional views of the display apparatus of FIG. 2 at various stages of construction in a fourth embodiment of a method of manufacturing a display apparatus according to the principles of the invention.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, the size and relative sizes of layers, films, panels, regions, etc., may be exaggerated for clarity and descriptive purposes. Also, like reference numerals denote like elements.

When an element or layer is referred to as being “on,” “connected to,” or “coupled to” another element or layer, it may be directly on, connected to, or coupled to the other element or layer or intervening elements or layers may be present. When, however, an element or layer is referred to as being “directly on,” “directly connected to,” or “directly coupled to” another element or layer, there are no intervening elements or layers present. For the purposes of this disclosure, “at least one of X, Y, and Z” and “at least one selected from the group consisting of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, etc. may be used herein to describe various elements, components, regions, layers, and/or sections, these elements, components, regions, layers, and/or sections should not be limited by these terms. These terms are used to distinguish one element, component, region, layer, and/or section from another element, component, region, layer, and/or section. Thus, a first element, component, region, layer, and/or section discussed below could be termed a second element, component, region, layer, and/or section without departing from the teachings of the present disclosure.

Spatially relative terms, such as “beneath,” “below,” “lower,” “above,” “upper,” and the like, may be used herein for descriptive purposes, and, thereby, to describe one element or feature's relationship to another element(s) or feature(s) as illustrated in the drawings. Spatially relative terms are intended to encompass different orientations of an apparatus in use, operation, and/or manufacture in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations), and, as such, the spatially relative descriptors used herein interpreted accordingly.

The terminology used herein is for the purpose of describing particular embodiments and is not intended to be limiting. As used herein, the singular forms, “a,” “an,” and “the” are intended to include the plural forms as well, unless the context clearly indicates otherwise. Moreover, the terms “comprises,” “comprising,” “includes,” and/or “including,” when used in this specification, specify the presence of stated features, integers, steps, operations, elements, components, and/or groups thereof, but do not preclude the presence or addition of one or more other features, integers, steps, operations, elements, components, and/or groups thereof.

Various exemplary embodiments are described herein with reference to sectional illustrations that are schematic illustrations of idealized exemplary embodiments and/or intermediate structures. As such, variations from the shapes of the illustrations as a result, for example, of manufacturing techniques and/or tolerances, are to be expected. Thus, exemplary embodiments disclosed herein should not be construed as limited to the particular illustrated shapes of regions, but are to include deviations in shapes that result from, for instance, manufacturing. For example, an implanted region illustrated as a rectangle will, typically, have rounded or curved features and/or a gradient of implant concentration at its edges rather than a binary change from implanted to non-implanted region. Likewise, a buried region formed by implantation may result in some implantation in the region between the buried region and the surface through which the implantation takes place. Thus, the regions illustrated in the drawings are schematic in nature and their shapes are not intended to illustrate the actual shape of a region of a device and are not intended to be limiting.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

Hereinafter, the inventive concepts will be explained in detail with reference to the accompanying drawings.

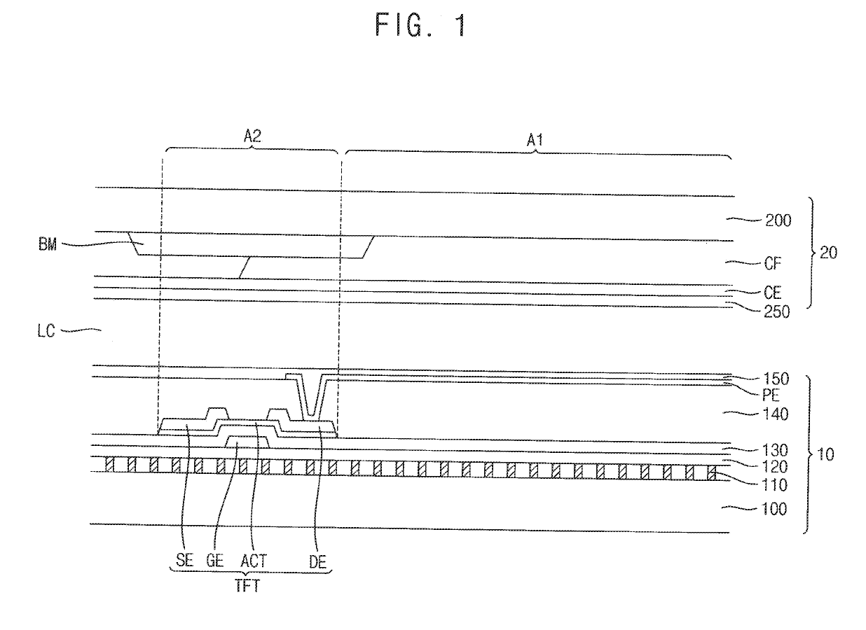

Referring to FIG. 1, the liquid crystal display apparatus may include a lower substrate 10, an upper substrate 20 which faces the lower substrate 10, and a liquid crystal layer LC disposed between the lower substrate 10 and the upper substrate 20.

The lower substrate 10 may include a first base substrate 100, a wire grid polarizer 110, a capping layer 120, a gate pattern, a first insulation layer 130, an active pattern ACT, a data pattern, a second insulation layer 140, a pixel electrode PE, and a lower alignment layer 150. The gate pattern includes a gate electrode GE. The data pattern includes a drain electrode DE and a source electrode SE.

The first base substrate 100 may include a material having excellent light transmittance, heat resistance, and chemical resistance. For example, the first base substrate 100 may include a glass substrate, a quartz substrate, a transparent resin substrate, or some other material. Examples of the transparent resin substrate for the first base substrate 100 may include polyimide-based resin, acryl-based resin, polyacrylate-based resin, polycarbonate-based resin, polyether-based resin, sulfonic acid containing resin, polyethyleneterephthalate-based resin, or some other transparent resin.

The wire grid polarizer 110 may be disposed on the first base substrate 100. The wire grid polarizer 110 may include a plurality of protrusions having same shape and formed in uniform distances to form a wire grid. The wire grid polarizer 110 may have a pitch of about 50 nm (nanometers) to about 150 nm. Preferably, the wire grid polarizer 110 may have about 90 nm of pitch. The pitch is defined as a sum of width of the protrusion and a distance between the protrusions adjacent to each other. The wire grid polarizer 110 may include a metal such as aluminum (Al), titanium (Ti), gold (Au), chromium (Cr), silver (Ag), copper (Cu), nickel (Ni), iron (Fe), cobalt (Co) or the like.

In some example embodiments, the wire grid polarizer 110 may be formed on a rear surface of the first base substrate 100 in an on-cell type wire grid polarizer.

The capping layer 120 may be disposed on the wire grid polarizer 110. The capping layer 120 may be formed using inorganic insulation material such as silicon oxide, a metal oxide, or the like.

The gate pattern may be disposed on the capping layer 120. The gate pattern may be formed using metal. The gate pattern may include a gate electrode GE and a signal line, such as a gate line, for driving a pixel.

The first insulation layer 130 may be disposed on the capping layer 120 on which the gate pattern is formed. The first insulation layer 130 may insulate the gate pattern and include a silicon compound, metal oxide, or some other material.

An active pattern ACT may be disposed to overlap the gate electrode GE on the first insulation layer 130. The active pattern ACT may include source and drain area which is an impurity-doped area, and a channel area between the source area and the drain area.

The data pattern may be disposed on the active pattern ACT. The data pattern may include a source electrode SE in contact with the source area, and a drain electrode DE in contact with the drain area. The data pattern may be formed using metal. The data pattern may further include a signal line, such as a data line, for driving the pixel.

The gate electrode GE, the active pattern ACT, the source electrode SE and the drain electrode DE may be included in a thin film transistor TFT.

The second insulation layer 140 may be disposed on the first insulation layer 130. The second insulation layer 140 may be formed using organic insulation material or inorganic insulation material.

The pixel electrode PE may be disposed on the second insulation layer 140. The pixel electrode PE may be electrically connected to the drain electrode DE of the thin film transistor TFT through a contact hole formed through the second insulation layer 140. The pixel electrode PE may include transparent conductive material. For example, the pixel electrode PE may be formed using the transparent conductive material such as indium tin oxide (ITO), indium zinc oxide (IZO) or the like.

The lower alignment layer 150 may be disposed on the second insulation layer 140 on which the pixel electrode PE is disposed. The lower alignment layer 150 may include a photo-alignment material. The photo-alignment material may include a photoreactive polymer. For example, the photo-alignment material includes polyimide main chains and side chains connected to the polyimide main chains. The side chains may have a double bond that makes the side chains have directionality. The directionality of a photo-alignment material means that molecules of the photo-alignment material are directed to or have a tendency to be directed to a predetermined direction.

When ultraviolet (UV) light polarized in a predetermined direction is irradiated to the photoreactive polymer aligned in random directions, optical reactors having directionality perpendicular to or parallel with the polarized direction of the polarized ultraviolet light are photopolymerized. For example, when ultraviolet light having a polarization axis is irradiated to the side chains, the side chains are photopolymerized to have structural anisotropy, and thus the photoreactive polymer obtains a pretilt direction tilted to the irradiating direction of the ultraviolet light.

In addition, polyimide is used as an example of the alignment material, but the photo-alignment material according to the present invention is not limited to polyimide. The photo-alignment material may include polyamic acid, polynorbornene, phenylmaleimide copolymer, polyvinyl cinnamate, polyazobenzene, polyethyleneimine, polyvinyl alcohol, polyamide, polyethylene, polystyrene, polyphenylene phthalamide, polyester, polyurethane, polymethyl methacrylate, or some other material.

The lower alignment layer 150 may include a first area A1 in which photo-alignment is performed, and a second area A2 in which photo-alignment is not performed. The second area A2 may overlap a metal pattern layer which includes the gate pattern and the data pattern. As previously mentioned, the gate pattern includes a gate electrode GE and the data pattern includes a drain electrode DE and a source electrode SE.

The upper substrate 20 may include a second base substrate 200, a black matrix BM, a color filter CF, a common electrode CE, and an upper alignment layer 450.

The second base substrate 200 may include a material having excellent light transmittance, heat resistance, and chemical resistance. For example, the second base substrate 200 may include a glass substrate, a quartz substrate, a transparent resin substrate, or some other material. Examples of the transparent resin substrate for the second base substrate 200 may include polyimide-based resin, acryl-based resin, polyacrylate-based resin, polycarbonate-based resin, polyether-based resin, sulfonic acid containing resin, polyethyleneterephthalate-based resin, or some other transparent resin.

The black matrix BM may be disposed on the second base substrate 200. The black matrix BM may be disposed corresponding to an area outside a pixel area in which the image is displayed, and may block light. Thus, the black matrix BM may overlap the data pattern, the gate pattern and the thin film transistor TFT.

Here, the black matrix BM may be formed larger than the metal pattern layer which includes the data pattern and the gate pattern to overlap entire of the metal pattern layer. Thus, the black matrix BM may be larger than the second area A2 and overlap some or all of the second area A2.

Accordingly, the black matrix BM overlaps a portion of the first area A1. Thus, although photo-alignment of the upper and lower alignment layers 250 and 150 at a boundary of the second area A2 and the first area A1 is not perfect, AC afterimage due to liquid crystal control failure might not be recognized by the user.

The color filter CF may be disposed on the second base substrate 200 on which the black matrix BM is disposed. The color filter CF may provide color to light transmitted through the liquid crystal layer LC. The color filter CF may be a red color filter (red), a green color filter (green), and a blue color filter (blue). The color filters CF may be provided corresponding to each of the pixels and may be arranged to have different colors between adjacent pixels. The color filters CF may be partially overlapped by adjacent color filters CF at boundaries of adjacent pixels, or the color filters CF may be spaced apart from the boundaries of adjacent pixels.

The common electrode CE may include transparent conductive material. The common electrode CE may be formed using the transparent conductive material such as indium tin oxide (ITO), indium zinc oxide (IZO) or the like

The upper alignment layer 250 may be disposed on the common electrode CE. The upper alignment layer 250 may include the alignment material.

The upper alignment layer 250 may also include the first area A1 in which photo-alignment is performed, and the second area A2 in which photo-alignment is not performed. A photo-alignment direction of the upper alignment layer 250 and a photo-alignment direction of the lower alignment layer 150 may be substantially the same direction.

Photo-alignment may be performed in part or all of the area of the upper alignment layer 250. A photo-alignment direction of the upper alignment layer 250 and a photo-alignment direction of the lower alignment layer 150 may be perpendicular to each other.

The liquid crystal layer LC may be disposed between the lower substrate and the upper substrate. The liquid crystal layer LC may include liquid crystal molecules having optical anisotropy. The liquid crystal molecules may be driven by an electric field to transmit or block light passing through the liquid crystal layer LC to display an image.

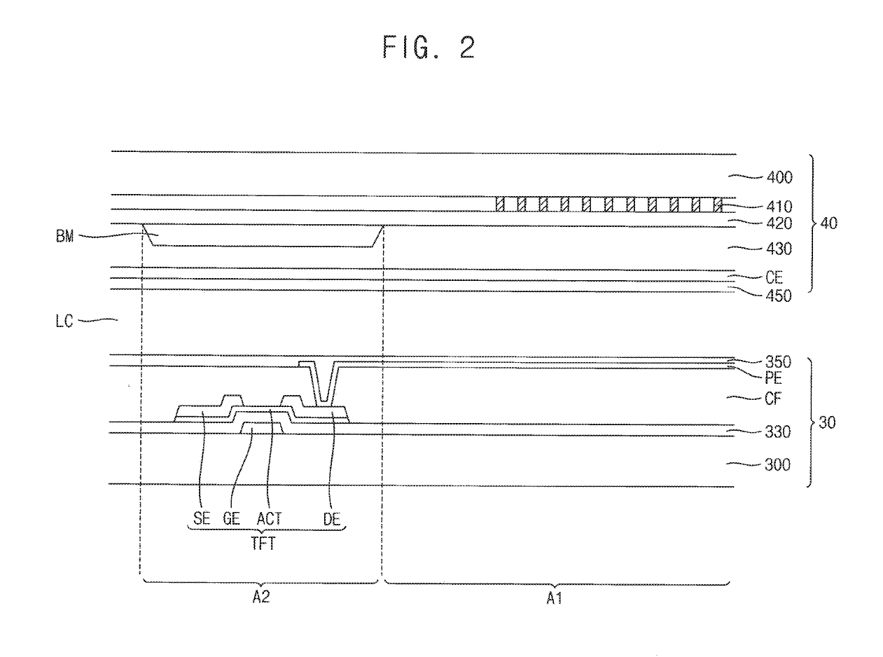

Referring to the embodiment of FIG. 2, the liquid crystal display apparatus may include a lower substrate 30, an upper substrate 40 which faces the lower substrate 30, and a liquid crystal layer LC disposed between the lower substrate 30 and the upper substrate 40.

The upper substrate 40 may include a second base substrate 400, a wire grid polarizer 410, a capping layer 420, a black matrix BM, an over-coating layer 430, a common electrode CE and an upper alignment layer 450.

The second base substrate 400 may be substantially the same as the second base substrate 200 of FIG. 1

The wire grid polarizer 410 may be disposed on the second base substrate 400. The wire grid polarizer 410 may be substantially the same as the wire grid polarizer 110 of FIG.

The capping layer 420 may be disposed on the wire grid polarizer 410. The capping layer 420 may be substantially the same as the capping layer 120 of FIG. 1.

The black matrix BM may be disposed on the capping layer 420. The black matrix BM may be substantially the same as the black matrix BM of FIG. 1.

The over-coating layer 430 may be disposed on the capping layer 420 on which the black matrix BM is disposed. The over-coating layer 430 may protect and planarize the black matrix BM and the capping layer 420 and may be formed using an acrylic epoxy material.

The common electrode CE may be disposed on the over-coating layer 430. The common electrode CE may be substantially the same as the common electrode CE of FIG. 1.

The upper alignment layer 450 may be disposed on the common electrode CE. The upper alignment layer 450 may include a photo-alignment material. The photo-alignment material may include a photoreactive polymer.

The upper alignment layer 450 may include a first area A1 in which photo-alignment is performed, and a second area A2 in which photo-alignment is not performed. The second area A2 may overlap the black matrix BM.

The lower substrate 30 may include a first base substrate 300, a gate pattern, a first insulation layer 330, an active pattern ACT, a data pattern, a color filter CF, a pixel electrode PE, and a lower alignment layer 350. The gate pattern and the data pattern may be substantially the same as FIG. 1. Thus, the gate pattern includes the gate electrode GE and the data pattern includes the drain electrode DE and the source electrode SE.

The first base substrate 300 may be substantially the same as the first base substrate 100 of FIG. 1.

The gate pattern may be disposed on the first base substrate 300. The first insulation layer 330 may be disposed on the first base substrate 300 on which the gate pattern is formed. The active pattern ACT may be disposed on the first insulation layer 330. The data pattern may be disposed on the active pattern ACT. The first insulation layer 330 and the active pattern ACT may be substantially the same as the first insulation layer 130 and the active pattern ACT of FIG. 1, respectively.

The color filter CF may be disposed on the first insulation layer 330 on which the data pattern is disposed. The color filter CF may be substantially the same as the color filter CF of FIG. 1.

The pixel electrode PE may be disposed on the color filter CF. The pixel electrode PE may be electrically connected to the drain electrode DE of a thin film transistor TFT through a contact hole formed through the color filter CF. The pixel electrode PE may be substantially the same as the pixel electrode PE of FIG. 1.

The lower alignment layer 350 may be disposed on the color filter CF on which the pixel electrode PE is disposed. The lower alignment layer 350 may include a photo-alignment material. The photo-alignment material may include a photoreactive polymer.

The lower alignment layer 350 may also include a first area A1 in which photo-alignment is performed, and a second area A2 in which photo-alignment is not performed, like the upper alignment layer 450. A photo-alignment direction of the upper alignment layer 450 and a photo-alignment direction of the lower alignment layer 350 may be substantially the same direction.

Photo-alignment may be performed in part or all of the area of the lower alignment layer 350. A photo-alignment direction of the upper alignment layer 450 and a photo-alignment direction of the lower alignment layer 350 may be perpendicular to each other.

The black matrix BM may be larger than a metal pattern which includes the gate pattern and the data pattern, so that the second area A2 is larger than the metal pattern. Alternatively, the black matrix BM may be smaller than the metal pattern, so that the metal pattern may be larger than the second area A2.

Exemplary methods of manufacturing the display apparatus according to the principles of the invention will now be described.

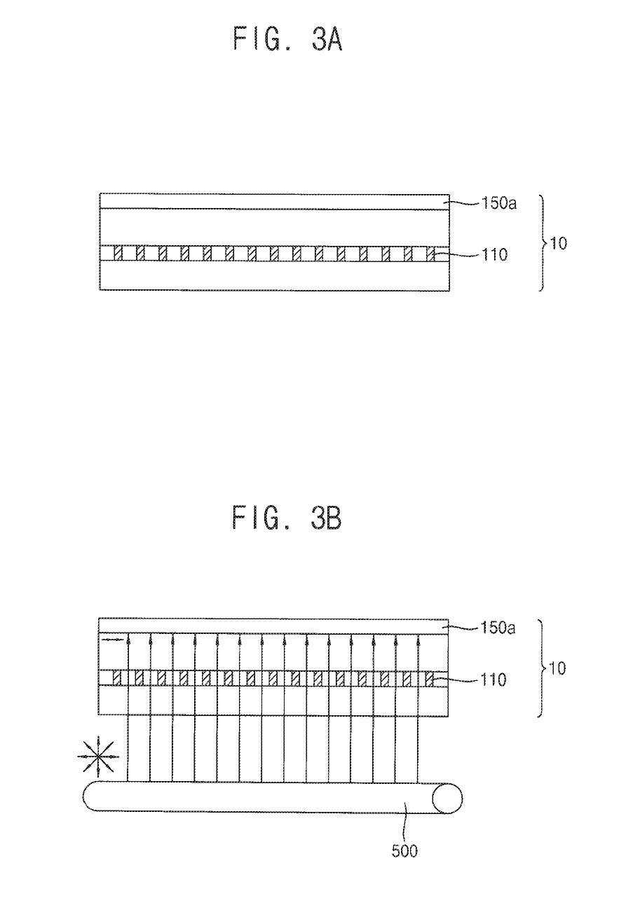

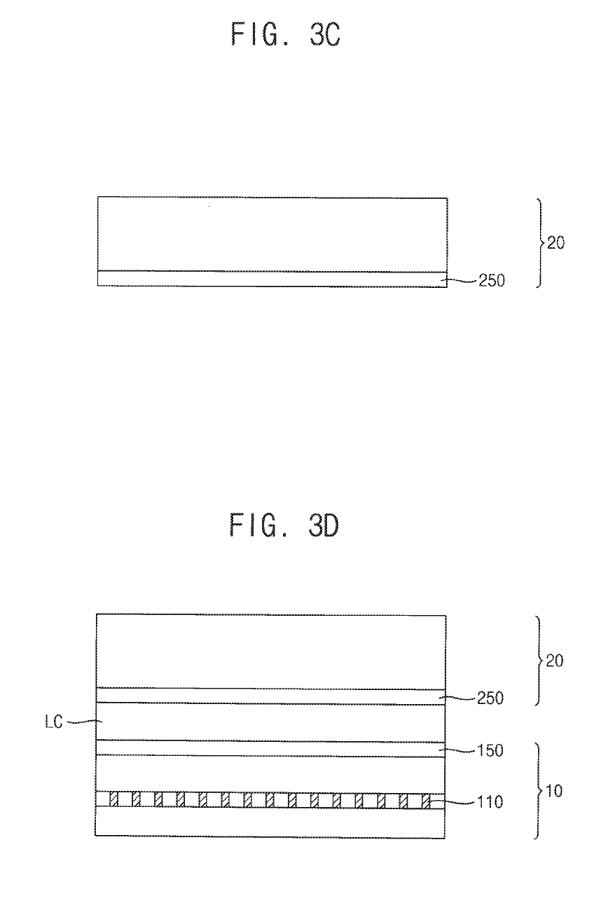

Referring to FIG. 3A, a lower substrate 10 may be provided. The lower substrate 10 may include a first base substrate, a wire grid polarizer 110, a capping layer, a gate pattern, a first insulation layer, an active pattern, a data pattern, a second insulation layer, a pixel electrode and a preliminary lower alignment layer 150a. The first base substrate, the wire grid polarizer 110, the capping layer, the gate pattern, the first insulation layer, the active pattern, the data pattern, the second insulation layer and the pixel electrode may be substantially the same as corresponding elements of FIG. 1. Certain aspects of this structure are omitted in FIG. 3A for clarity.

The preliminary lower alignment layer 150a may be formed by coating a photo-alignment material including photoreactive polymer on the lower substrate 10. The preliminary lower alignment layer 150a is in a state in which photo-alignment has not yet been performed, i.e., a state before the polarized ultraviolet light is irradiated.

Referring to 3B, ultraviolet light may be irradiated into the lower substrate 10 using an ultraviolet irradiator 500. The ultraviolet irradiator 500 may generate ultraviolet light that is not polarized and may emit the ultraviolet light towards and into the lower substrate 10. The ultraviolet light may pass the wire grid polarizer 110 of the lower substrate 10 and be polarized, so that ultraviolet light may subsequently be irradiated towards and into the preliminary lower alignment layer 150a in a polarized state. Accordingly, the preliminary lower alignment layer 150a is photo-aligned, so that a lower alignment layer 150 is formed. The lower alignment layer 150 is no longer in a preliminary state.

The ultraviolet light may have a peak wavelength of about 300 nm (nanometer) to about 500 nm, and a pitch of the wire grid polarizer 110 may be about 50 nm to about 150 nm. Preferably, the peak wavelength of the ultraviolet light is about 3560 nm (nanometer), and the pitch of the wire grid polarizer 110 is about 90 nm.

In the described method, the ultraviolet irradiator 500 need not be configured to emit polarized ultraviolet light, and general ultraviolet lamps can be used for the ultraviolet irradiator 500. In addition, because un-polarized ultraviolet light is polarized while passing through the wire grid polarizer 110 of the lower substrate 10 in the described method, an additional alignment process for aligning the alignment direction of the alignment layer and the polarizer of the display apparatus is not necessary. In other words, in the described method, the apparatus is self-aligned.

In addition, the lower substrate 10 includes a metal pattern layer including the gate pattern and the data pattern which is formed of a metal. When the metal pattern layer is opaque, the ultraviolet light does not pass through the metal pattern layer, so that a portion of the lower alignment layer 150 might not be photo-aligned. This corresponds to the second area A2 described above in connection with FIG. 1 and FIG. 2

Referring to FIG. 3C, an upper substrate 20 may be provided. The upper substrate 20 may include a second base substrate, a black matrix, a color filter, a common electrode and an upper alignment layer 250. Certain aspects of this structure are omitted in FIG. 3C for the sake of clarity. The second base substrate, the black matrix, the color filter and the common electrode may be substantially the same as corresponding elements of FIG. 1.

The upper alignment layer 250 may be formed using a conventional photo-alignment method.

Referring to FIG. 3D, a liquid crystal layer LC may be formed between the lower substrate 10 and the upper substrate 20. The liquid crystal layer LC may be formed by a generally known method. Thereafter, an additional process may be performed to complete the liquid crystal display apparatus. For example, the liquid crystal display apparatus may be manufactured by attaching a polarizer on the upper substrate 20. The upper substrate 20 may include a wire grid polarizer instead of the polarizer.

Accordingly, the liquid crystal display apparatus may be manufactured as described.

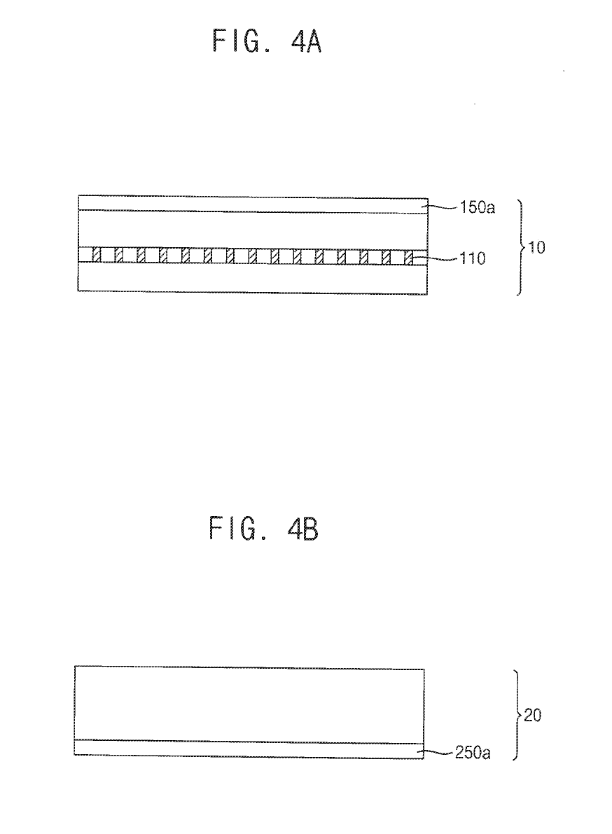

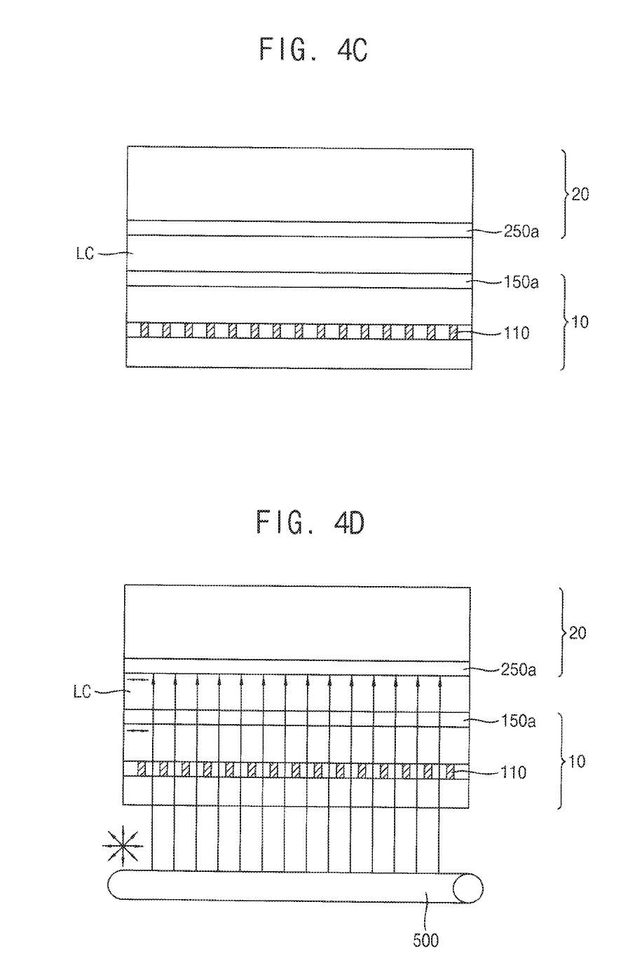

Referring to exemplary method illustrated in FIG. 4A, a lower substrate 10 may be provided. The lower substrate 10 may be substantially the same as the lower substrate 10 of FIG. 3A.

A preliminary lower alignment layer 150a may be formed by coating a photo-alignment material including photoreactive polymer on the lower substrate 10. The preliminary lower alignment layer 150a is in a state in which photo-alignment has not yet been performed thereon. In other words, the state of the lower alignment layer 150a is before the polarized ultraviolet light is irradiated thereto.

Referring to FIG. 4B, an upper substrate 20 may be provided. The upper substrate 20 may include a second base substrate, a black matrix, a color filter, a common electrode and a preliminary upper alignment layer 250a. Certain aspects of this structure are omitted in FIG. 4B for the sake of clarity. The second base substrate, the black matrix, the color filter and the common electrode may be substantially the same as corresponding elements of FIG. 1.

The preliminary upper alignment layer 250a may be formed by coating a photo-alignment material including photoreactive polymer on the upper substrate 20. The preliminary upper alignment layer 250a is in a state that photo-alignment has not yet performed thereto. In other words, the state of the preliminary upper alignment layer 250a is before the polarized ultraviolet light is irradiated thereto.

Referring to FIG. 4C, a liquid crystal layer LC may be formed between the lower substrate 10 and the upper substrate 20. The liquid crystal layer LC may be formed by a generally known method.

Referring to FIG. 4D, ultraviolet light may be irradiated to the lower substrate 10 and the upper substrate 20 using an ultraviolet irradiator 500. The ultraviolet irradiator 500 may generate ultraviolet light that is not polarized and may emit the ultraviolet light into the lower substrate 10 and the upper substrate 20. The ultraviolet light may pass the wire grid polarizer 110 of the lower substrate 10 and be polarized, so that ultraviolet light may thereafter be irradiated towards and into the preliminary lower alignment layer 150a in a polarized state. Accordingly, the preliminary lower alignment layer 150a is photo-aligned, so that a lower alignment layer 150 is formed. In addition, the polarized ultraviolet light may pass through the liquid crystal layer LC and be irradiated towards and into the preliminary upper alignment layer 250a of the upper substrate 20. Accordingly, the preliminary upper alignment layer 250a is photo-aligned, so that an upper alignment layer 250 is formed.

The ultraviolet light may have a peak wavelength of about 300 nm (nanometer) to about 500 nm, and a pitch of the wire grid polarizer 110 may be about 50 nm to about 150 nm. Preferably, the peak wavelength of the ultraviolet light is about 3560 nm (nanometer), and the pitch of the wire grid polarizer 110 is about 90 nm.

In addition, the liquid crystal layer LC may be in OFF state, so that the polarizing direction of the polarized ultraviolet light may be maintained while the polarized ultraviolet light passes the liquid crystal layer LC. Accordingly, an alignment direction of the lower alignment layer 150 and an alignment direction of the upper alignment layer 250 may be substantially the same direction.

In addition, since the wire grid polarizer 110 of the liquid crystal display apparatus is used to polarize the ultraviolet light, photo-alignment of the upper alignment layer 250 and the lower alignment layer 150 can be performed at the same time.

In addition, in the above described single process, since the alignment direction of the upper alignment layer 250 and the alignment direction of the lower alignment layer 150 are aligned in the same manner, the contrast ratio is improved and the display quality can be improved.

Although the alignment direction of the lower alignment layer 150 is substantially the same as that of the upper alignment layer 250 in the method described above, the liquid crystal layer LC may be turned on to be in an ON state during the photo-alignment process. In that case, the light alignment directions of the lower alignment layer 150 and the upper alignment layer 250 may be perpendicular to each other.

In addition, the lower substrate 10 includes a metal pattern layer (which includes the gate pattern and the data pattern) formed from metal. When the metal pattern layer is opaque, the ultraviolet light cannot pass the metal pattern layer, so that a portion of the lower alignment layer 150 and a portion of the upper alignment layer 250 might not be photo-aligned. This corresponds to the second area A2 of FIG. 1 and FIG. 2.

Then, an additional process to complete the liquid crystal display apparatus may be performed. Accordingly, the liquid crystal display apparatus may be manufactured in a variety of ways as described above.

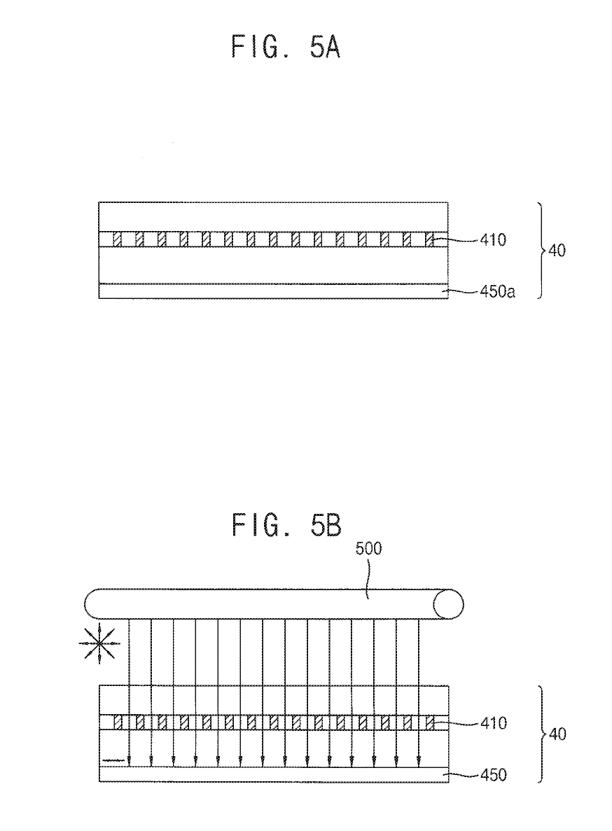

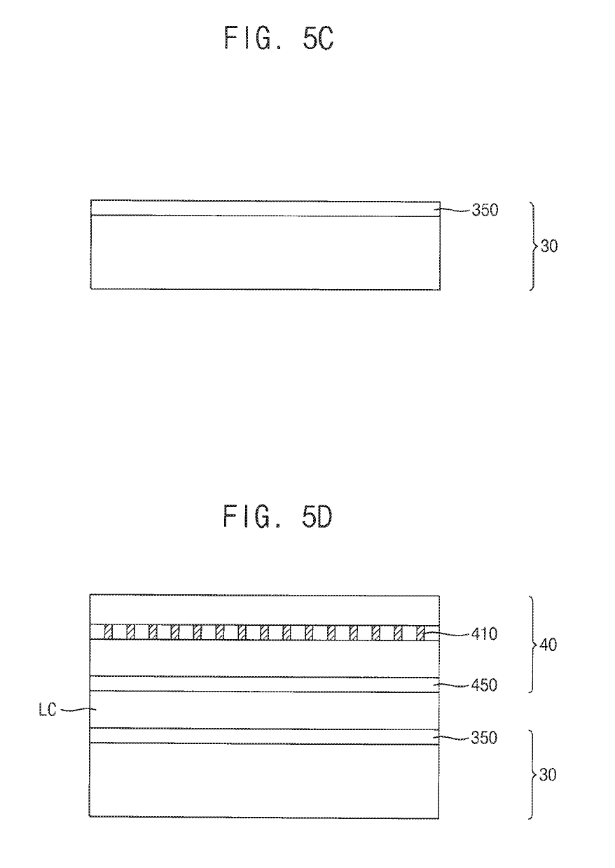

Referring to exemplary method illustrated in FIG. 5A, an upper substrate 40 may be provided. The upper substrate 40 may include a second base substrate, a wire grid polarizer 410, a capping layer, a black matrix, an over-coating layer, a common electrode and a preliminary upper alignment layer 450a. Certain aspects of this structure are omitted in FIG. 5A for the sake of clarity. The second base substrate, the wire grid polarizer 410, the capping layer, the black matrix, the over-coating layer and the common electrode may be substantially the same as corresponding elements of FIG. 2.

The preliminary upper alignment layer 450a may be formed by coating a photo-alignment material including photoreactive polymer on the upper substrate 40. The preliminary upper alignment layer 450a is in a state in which photo-alignment has not yet performed thereon. In other words, the state of the preliminary upper alignment layer 450a is before the polarized ultraviolet light is irradiated thereto.

Referring to 5B, ultraviolet light may be irradiated to the upper substrate 40 using an ultraviolet irradiator 500. The ultraviolet irradiator 500 may generate ultraviolet light that is not polarized and may emit the ultraviolet light to the upper substrate 40. The ultraviolet light may pass the wire grid polarizer 410 of the upper substrate 40 and be polarized, so that ultraviolet light may be irradiated to the preliminary upper alignment layer 450a. Accordingly, the preliminary upper alignment layer 450a is photo-aligned, so that an upper alignment layer 450 is formed.

The ultraviolet light may have a peak wavelength of about 300 nm (nanometer) to about 500 nm, and a pitch of the wire grid polarizer 110 may be about 50 nm to about 150 nm. Preferably, the peak wavelength of the ultraviolet light is about 3560 nm (nanometer), and the pitch of the wire grid polarizer 110 is about 90 nm.

In addition, the upper substrate 40 includes the black matrix which blocks light. The ultraviolet light cannot pass the black matrix, so that a portion of the upper alignment layer 450 might not be photo-aligned. This corresponds to the second area A2 of FIG. 1 and FIG. 2.

Referring to FIG. 5C, a lower substrate 30 may be provided. The lower substrate 30 may include a first base substrate, a gate pattern, a first insulation layer, an active pattern, a data pattern, a color filter, a pixel electrode and a lower alignment layer 350. Certain aspects of this structure are omitted in FIG. 5C for the sake of clarity. The first base substrate, the gate pattern, the first insulation layer, the active pattern, the data pattern, the color filter and the pixel electrode may be substantially the same as corresponding elements of FIG. 2.

The lower alignment layer 350 may be formed using a conventional photo-alignment method.

Referring to FIG. 5D, a liquid crystal layer LC may be formed between the lower substrate 30 and the upper substrate 40. The liquid crystal layer LC may be formed by a generally known method.

Thereafter, an additional process may be performed to complete the liquid crystal display apparatus.

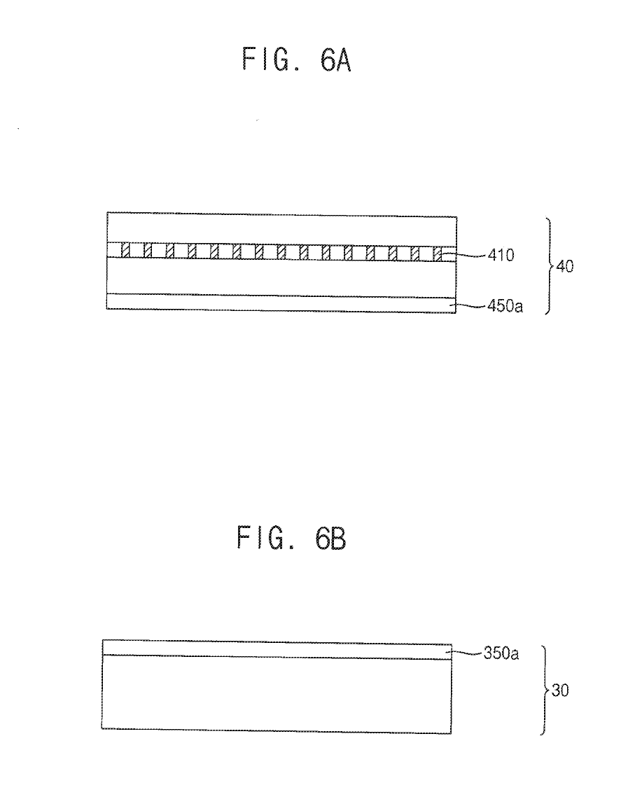

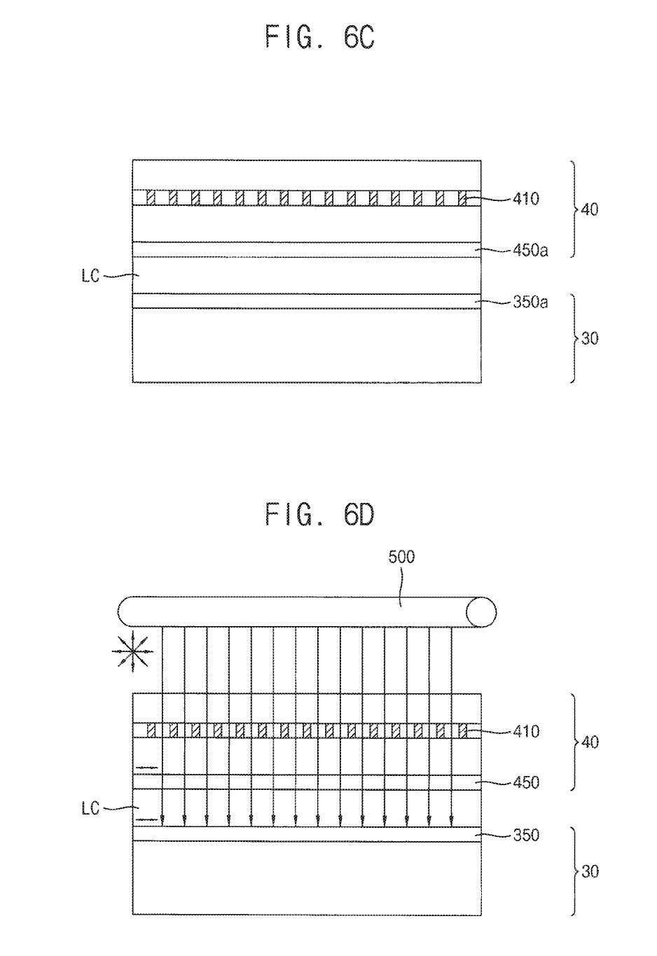

Referring to exemplary method illustrated in FIG. 6A, an upper substrate 40 may be provided. The upper substrate 40 may be substantially the same as the upper substrate 40 of FIG. 5A.

A preliminary upper alignment layer 450a may be formed by coating a photo-alignment material including photoreactive polymer on the upper substrate 40. The preliminary upper alignment layer 450a is in a state in which photo-alignment has not yet been performed. In other words, the state of the preliminary upper alignment layer 450a is before the polarized ultraviolet light has been irradiated thereto.

Referring to FIG. 6B, a lower substrate 30 may be provided. The lower substrate 30 may include a first base substrate, a gate pattern, a first insulation layer, an active pattern, a data pattern, a color filter, a pixel electrode and a preliminary lower alignment layer 350a. Certain aspects of this structure are omitted in FIG. 6B for the sake of clarity. The first base substrate, the gate pattern, the first insulation layer, the active pattern, the data pattern, the color filter and the pixel electrode may be substantially the same as corresponding elements of FIG. 2.

The preliminary lower alignment layer 350a may be formed by coating a photo-alignment material including photoreactive polymer on the lower substrate 30. The preliminary lower alignment layer 350a is in a state that photo-alignment is not performed, before the polarized ultraviolet light is irradiated.

Referring to FIG. 6C, a liquid crystal layer LC may be formed between the lower substrate 30 and the upper substrate 40. The liquid crystal layer LC may be formed by a generally known method.

Referring to FIG. 6D, ultraviolet light may be irradiated into the lower substrate 30 and the upper substrate 40 using an ultraviolet irradiator 500. The ultraviolet irradiator 500 may generate ultraviolet light that is not polarized and may emit the ultraviolet light towards and into the lower substrate 30 and the upper substrate 40. The ultraviolet light may pass the wire grid polarizer 410 of the upper substrate 40 and be polarized, so that ultraviolet light may thereafter be irradiated towards and into the preliminary upper alignment layer 450a. Accordingly, the preliminary upper alignment layer 450a is photo-aligned, so that an upper alignment layer 450 is formed. In addition, the polarized ultraviolet light may pass through the liquid crystal layer LC and thereafter be irradiated towards and into the preliminary lower alignment layer 350a of the lower substrate 30. Accordingly, the preliminary lower alignment layer 350a is photo-aligned, so that a lower alignment layer 350 is formed.

The ultraviolet light may have a peak wavelength of about 300 nm (nanometer) to about 500 nm, and a pitch of the wire grid polarizer 410 may be about 50 nm to about 150 nm. Preferably, the peak wavelength of the ultraviolet light is about 3560 nm (nanometer), and the pitch of the wire grid polarizer 410 is about 90 nm.

In addition, the liquid crystal layer LC may be in OFF state, so that a polarizing direction of the polarized ultraviolet light may be maintained while the polarized ultraviolet light passes the liquid crystal layer LC. Accordingly, an alignment direction of the lower alignment layer 350 and an alignment direction of the upper alignment layer 450 may be substantially the same direction.

Although the alignment direction of the lower alignment layer 350 is substantially the same as that of the upper alignment layer 450 in the method described above, the liquid crystal layer LC may alternatively be turned on to be in ON state during the photo-alignment process, so that the light alignment directions of the lower alignment layer 350 and the upper alignment layer 450 may be perpendicular to each other.

In addition, the upper substrate 40 includes the black matrix which blocks light. The ultraviolet light cannot pass the black matrix, so that a portion of the upper alignment layer 450 and a portion of the upper alignment layer 450 might not be photo-aligned. This corresponds to the second area A2 of FIG. 1 and FIG. 2.

Thereafter, an additional process may be performed to complete the liquid crystal display apparatus.

The polarized ultraviolet light may change its polarization characteristic while passing through the color filter depending on constituent material of the color filter. Therefore, when the ultraviolet light is irradiated onto the lower substrate 30 through the upper substrate 40, it is beneficial to include the color in the lower substrate 30.

According to the foregoing principles of the invention, a liquid crystal display apparatus may include a wire grid polarizer and an alignment layer which includes a first area in which photo-alignment is performed and a second area in which photo-alignment is not performed. In manufacturing the liquid crystal display apparatus, because un-polarized ultraviolet light is polarized by passing through the wire grid polarizer of the liquid crystal display apparatus, an additional ultraviolet irradiator alignment process for aligning the alignment direction of the alignment layer and the polarizer of the display apparatus are obviated.

In addition, since the wire grid polarizer of the liquid crystal display apparatus is used to polarize the ultraviolet light, the photo-alignment of an upper alignment layer and a lower alignment layer can be performed at the same time in a single process step.

In addition, because an alignment direction of the upper alignment layer and an alignment direction of the lower alignment layer are aligned in substantially the same manner, the contrast ratio is improved and display quality can be improved.

In addition, an ultraviolet irradiator need not be configured to emit polarized ultraviolet light, and general ultraviolet lamps can be used for the ultraviolet irradiator.

In addition, if black matrix is larger than the second area where the photo-alignment is not performed, the AC afterimage evident to the user due to liquid crystal control failure in the second area is reduced or eliminated.

Although certain exemplary embodiments and implementations have been described herein, other embodiments and modifications will be apparent from this description. Accordingly, the inventive concepts are not limited to such embodiments, but rather to the broader scope of the presented claims and various obvious modifications and equivalent arrangements.

What is claimed is:

1. A liquid crystal display apparatus, comprising:
a first substrate comprising:
a first base substrate;
a wire grid polarizer disposed on the first base substrate; and
a first alignment layer disposed on the first base substrate and comprising photo-alignment material, wherein the first alignment layer includes a first area in which photo-alignment is performed and a second area in which photo-alignment is not performed;
a second substrate spaced from the first substrate; and
a liquid crystal layer disposed between the first substrate and the second substrate.

2. The liquid crystal display apparatus of claim 1, wherein the first substrate comprises a metal pattern layer,
the first area overlaps the metal pattern layer.

3. The liquid crystal display apparatus of claim 2, wherein the metal pattern layer comprises a gate pattern having a gate electrode, and a data pattern having a drain electrode and a source electrode.

4. The liquid crystal display apparatus of claim 2, wherein a photo-alignment direction of the first alignment layer and a photo-alignment direction of a second alignment layer are substantially the same.

5. The liquid crystal display apparatus of claim 1, wherein the second substrate comprises:
a second base substrate; and
a second alignment layer disposed on the second base substrate and including a photo-alignment material, wherein the second alignment layer has a first area in which photo-alignment has been performed and a second area in which photo-alignment has not been performed.

6. The liquid crystal display apparatus of claim 1, wherein the second substrate further comprises a black matrix which blocks light,
the black matrix being larger than the second area, and entirely overlapping the second area.

7. The liquid crystal display apparatus of claim 1, wherein the first substrate further comprises a color filter between the first base substrate and the first alignment layer.

8. The liquid crystal display apparatus of claim 1, wherein the second substrate further comprises a color filter disposed on the second base substrate.

9. The liquid crystal display apparatus of claim 1, wherein a pitch of the wire grid polarizer is about 50 nm to about 150 nm.

10. The liquid crystal display apparatus of claim 1, wherein the first substrate comprises a lower substrate and the second substrate comprises an upper substrate.

11. The liquid crystal display apparatus of claim 1, wherein the first substrate comprises an upper substrate and the second substrate comprises a lower substrate.

12. A method of manufacturing a liquid crystal display apparatus, the method comprising the steps of:
providing a lower substrate having a first base substrate and a wire grid polarizer disposed on the first base substrate;
forming a preliminary lower alignment layer having a photo-alignment material on the lower substrate; and
irradiating ultraviolet light through the wire grid polarizer into the preliminary lower alignment layer, thereby forming a photo-aligned lower alignment layer.

13. The method of claim 12, further comprising:
providing an upper substrate including a second base substrate;
forming a preliminary upper alignment layer including a photo-alignment material on the upper substrate; and
forming a liquid crystal layer between the lower substrate and the upper substrate, wherein
the step of irradiating the ultraviolet light is performed after the step of forming the liquid crystal layer, and
the ultraviolet light sequentially passes through the wire grid polarizer and the liquid crystal layer and is irradiated into the preliminary upper alignment layer to form an upper alignment layer, thereby photo-aligning the lower alignment layer and the upper alignment layer.

14. The method of claim 13, wherein, in the step of irradiating the ultraviolet light, the liquid crystal layer is in an OFF state, whereby the ultraviolet light passing through the liquid crystal layer maintains its state of polarization.

15. The method of claim 14, further comprising photo-aligning the lower alignment layer and photo-aligning the upper alignment layer in substantially the same direction.

16. The method of claim 13, wherein
the step of providing a lower substrate comprises providing a lower substrate having a metal pattern layer,
the step of irradiating ultraviolet light into the preliminary lower alignment layer comprises irradiating the ultraviolet light into a first area of the preliminary lower alignment layer and not irradiating the ultraviolet light into a second area of the preliminary lower alignment layer, and
the first area overlaps the metal pattern layer.

17. The method of claim 14, wherein the step of irradiating the ultraviolet light comprises generating un-polarized ultraviolet light from an ultraviolet irradiator and irradiating the un-polarized ultraviolet light towards the first substrate in an un-polarized state, whereby the ultraviolet light is polarized by passing through the wire grid polarizer.

18. The method of claim 14, wherein the step of irradiating the ultraviolet light comprises generating ultraviolet light having a peak wavelength of about 300 nm (nanometer) to about 500 nm.

19. A method of manufacturing a liquid crystal display apparatus, the method comprising the steps of:
providing a lower substrate having a first base substrate and a thin film transistor formed on the first base substrate;
providing an upper substrate having a second base substrate and a wire grid polarizer formed on the second base substrate;
forming a preliminary upper alignment layer including a photo-alignment material on the upper substrate; and
irradiating un-polarized ultraviolet light through the wire grid polarizer into the preliminary upper alignment layer, thereby forming a photo-aligned upper alignment layer.

20. The method of claim 19, further comprising:
forming a preliminary lower alignment layer having a photo-alignment material on the lower substrate; and
forming a liquid crystal layer between the lower substrate and the upper substrate, wherein
the step of irradiating un-polarized ultraviolet light is performed after the step of forming the liquid crystal layer, and
the un-polarized ultraviolet light sequentially passes through the wire grid polarizer and the liquid crystal layer and into the preliminary lower alignment layer to form a lower alignment layer, thereby photo-aligning the lower alignment layer and the upper alignment layer.
